(19) United States
(12) Patent Application Publication
(10) Pub. No.: US 2015/0379392 A1
(43) Pub. Date: Dec. 31, 2015

(54) INFORMATION PROCESSING SYSTEM, USER TERMINAL, INFORMATION PROCESSING METHOD AND NON-TRANSITORY RECORDING MEDIUM STORING PROGRAM

(71) Applicant: COCORO INC., Fujisawa-shi (JP)

(72) Inventor: Naoki SHIGYO, Fujisawa-shi (JP)

(73) Assignee: COCORO INC., Fujisawa-shi (JP)

(21) Appl. No.: 14/316,355

(22) Filed: Jun. 26, 2014

(51) Int. Cl. G06N 3/00; G06T 13/80

(52) U.S. Cl. CPC G06N 3/006; G06T 13/80

(57) ABSTRACT

An information processing system, a server, a user terminal, an information processing method, and a program capable of effectively realizing psychological exchanges among users is provided. A user terminal 110 includes a terminal-side display control unit 113 that generates a first flower image corresponding to a first user, a display unit 111 that displays an image generated by the terminal-side display control unit 113, and an input unit 112 that receives a first input operation by the first user. The terminal-side display control unit 113 changes the first flower image according to the first input operation.

### BACKGROUND OF THE INVENTION

1. Field of the Invention

The present invention relates to an information processing system, a user terminal, an information processing method, and a non-transitory recording medium storing a program. In particular, the present invention relates to a communication technique.

2. Description of Related Art

These days, electronic mail, SNSs (Social Networking Services), telephones, videophones, and so on are widely used as remote communication media. In these typical remote communication media, the amount of exchanged information has been increasing as time passes in order to reduce the communication gap as much as possible. Further, the data that can be handled in these remote communication media include a wide variety of data types, including text data, image data, and moving-image data.

For example, Japanese Unexamined Patent Application Publication No. 2002-312612 discloses a system capable of performing interactions with other users through activities of a character representing the user in a virtual space on a network for the purpose of reinforcing conventional text-based communication. Japanese Unexamined Patent Application Publication No. 2002-312612 also discloses a method for providing advertisement information to users in a virtual space.

### SUMMARY OF THE INVENTION

The purpose of the above-described conventional remote communication media is to share information, in particular, physical information (i.e., information that can be easily quantified) including languages. However, to use physical information for the purpose of communication, in the nature of things, it is necessary for those participating in the communication to share common accurate definitions (including nuances) for the physical information to be used in advance. However, both the combination of those participating in the communication and the physical information itself are enormous. Therefore, sharing such common definitions in advance is almost impossible. Further, there is a dilemma that such definitions also have to be made by using physical information. In recent human society, this is the fundamental cause for the frequent occurrences of communication gaps.

Therefore, to sufficiently support the communication in human society by using remote media, it is indispensable that users thereof unveil their respective psychological states to each other and that they approve the respective psychological states of each other, i.e., to perform psychological exchanges in addition to sharing physical information. No remote communication media for performing such psychological exchanges have been developed in the past.

Further, to realize such psychological exchanges, it is indispensable to develop a technique that enables users to unveil their psychological states. As techniques for facilitating such psychological state unveiling, there is psychological unveiling in which users are not aware of the unveiling and psychological unveiling in which users are aware of the unveiling. The psychological unveiling in which users are not aware of the unveiling is a technique in which an observer entirely infers the psychological state of a user by externally observing the user. Examples of such techniques include an expression analysis, a behavior analysis, and a text analysis. Further, examples of such techniques include a psychological game or a quiz(s) that is performed while concealing the intention of the observer, and monitoring of vital signs.

Meanwhile, the psychological unveiling in which users are aware of the unveiling is a technique in which a user unveils his/her psychological state by himself/herself based on some motivation. This motivation is created by an external motivation or an internal motivation. Examples of external motivations include an obligation, a reward/punishment, and coercion. Examples of specific techniques include an inquiry (psychological test), a questionnaire with an obligation or a reward, monitoring of vital signs such as that done by a polygraph, a suggestion, and a hypnosis. Under an external motivation, a user unveils his/her psychological state as means for attaining some objective.

Meanwhile, an internal motivation is, for example, a motivation caused by curiosity, concern, or the like. Natural psychological unveiling in daily friendly communication falls within the scope of an internal motivation. In an internal motivation, a user unveils his/her psychological state just for the purpose of unveiling. Further, to maximize the effect of psychological exchanges even in remote communication media, it is desirable to realize a technology enabling psychological unveiling in which users are aware of the unveiling caused by such internal motivations. However, such technologies have not been disclosed yet.

Further, no technique for quantifying psychological unveiling performed by a user based on such an internal motivation in order to convey the psychological unveiling to other users by using an information processing system and to give a feedback to the user himself/herself has been developed yet.

The present invention has been made to solve such problems, and an object thereof is to provide an information processing system, a user terminal, an information processing method, and a non-transitory recording medium storing a program capable of effectively realizing psychological exchanges among users.

The other problems to be solved and novel features of the present invention will become more fully understood from the descriptions in this specification and the accompanying drawings.

A user terminal according to an aspect of the present invention includes: a terminal-side display control unit that generates a first flower image corresponding to a first user; a display unit that displays an image generated by the terminal-side display control unit; and an input unit that receives a first input operation by the first user, in which the terminal-side display control unit changes the first flower image according to the first input operation.

An information processing system according to an aspect of the present invention includes: a user terminal according to Claims 2 or 3; and a serve, in which the server includes a server-side display control unit capable of communicating with the terminal-side display control unit, and at least one of the terminal-side display control unit and the server-side display control unit holds at least one of first data corresponding to the basic shape and a first parameter corresponding to the shape state.

An information processing system according to another aspect of the present invention includes: a user terminal including a terminal-side display control unit that generates an image, a display unit that displays the image, and an input unit that receives an input operation by a first user; and a server including a server-side display control unit capable of communicating with the terminal-side display control unit, in which the server-side display control unit holds second data corresponding to a basic shape of a second flower corresponding to a second user and a second parameter corresponding to a shape state of the second flower, and the terminal-side display control unit generates an image of the second flower according to the second data and the second parameter.

An information processing method according to an aspect of the present invention includes: a generation step of generating a first flower image corresponding to a first user; an input step of receiving a first input operation by the first user; and a change step of changing the first flower image according to the first input operation.

An information processing method according to another aspect of the present invention includes: a step of holding, by a server-side display control unit, second data corresponding to a basic shape of a second flower corresponding to a second user and a second parameter corresponding to a shape state of the second flower, and a step of generating, by a terminal-side display control unit, an image of the second flower according to the second data and the second parameter.

A program according to an aspect of the present invention is a program for causing a computer to execute both or either of the above-described information processing methods.

According to the present invention, it is possible to provide an information processing system, a user terminal, an information processing method, and a program capable of effectively realizing psychological exchanges among users.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 shows a configuration of an information processing system 100 according to an exemplary embodiment of the present invention;

FIG. 2 shows a process of an information processing system 100 according to an exemplary embodiment of the present invention;

FIG. 3 shows a process of an information processing system 100 according to an exemplary embodiment of the present invention;

FIG. 4 shows a process of an information processing system 100 according to an exemplary embodiment of the present invention;

FIG. 5 shows a process of an information processing system 100 according to an exemplary embodiment of the present invention;

FIG. 6 shows a process of an information processing system 100 according to an exemplary embodiment of the present invention;

FIG. 7 shows an example of a screen of an information processing system 100 according to an exemplary embodiment of the present invention;

FIG. 8 shows an example of a screen of an information processing system 100 according to an exemplary embodiment of the present invention;

FIG. 9 shows an example of a screen of an information processing system 100 according to an exemplary embodiment of the present invention;

FIG. 10 shows an example of a screen of an information processing system 100 according to an exemplary embodiment of the present invention;

FIG. 11 shows an example of a screen of an information processing system 100 according to an exemplary embodiment of the present invention;

FIG. 12 shows a process of an information processing system 100 according to an exemplary embodiment of the present invention;

FIG. 13 shows an example of a screen of an information processing system 100 according to an exemplary embodiment of the present invention;

FIG. 14 shows a process of an information processing system 100 according to an exemplary embodiment of the present invention;

FIG. 15 shows an example of a screen of an information processing system 100 according to an exemplary embodiment of the present invention;

FIG. 16 shows a process of an information processing system 100 according to an exemplary embodiment of the present invention; and

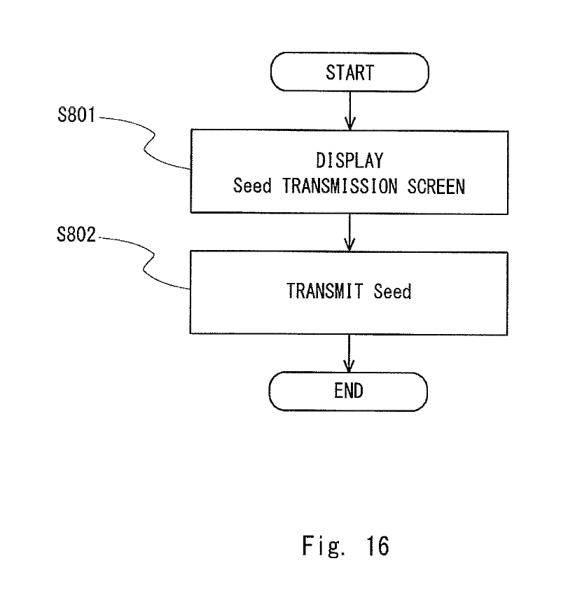

FIG. 17 shows a process of an information processing system 100 according to an exemplary embodiment of the present invention.

### DESCRIPTION OF THE EXEMPLARY EMBODIMENTS

Firstly, a typical user experience that is realized according to an aspect of the present invention is briefly explained to facilitate the understanding of the present invention.

### (Initial Startup: Generation of User Flower Image)

Firstly, a user starts up an application according to an aspect of the present invention installed in a smart phone or the like. When the application is started up for the first time, a “flower” of the user is born in the application according to the proactive operation of the user. The user recognizes that flower as being an avatar of himself/herself based on the interface and the visual expression at that point.

### (Sync Screen: Projection of User's Psychological State)

The user can adjust the shape of the flower by performing a touching operation on this flower. The interface and the visual expression in that operation make the user proactively want to project (or synchronize) his/her psychological state onto (or with) his/her flower (Sync). For example, the user may want to adjust the posture of the flower according to his/her mood or his/her condition, or to adjust the color tone of the flower according to his/her fulfillment or his/her happiness.

### (Care Screen: Psychological Approach to Other Users)

The user can see the flowers of any other given users. Further, the user can make various approaches to those flowers or take care of those flowers (Care) by performing motion actions of the smart phone or the like. For example, the user can water the flowers of other users. Further, the user can give sunlight and/or a gentle breeze to the flowers of other users. Users who receive the “Care” are made aware of the Care given by the other user by a notification. In this way, users exchange only their emotions such as approval and empathy to each other without using physical information such as languages and video images. Through such communication, the user's desire to synchronize his/her psychological state with his/her flower becomes deeper and deeper.

### (View Screen: List View of Users)

The user can view a state in which the flowers of all the users are in bloom and his/her own flower is positioned at the center of all the other flowers. They bloom in such a manner that the flowers of certain other users that the user gives greater care to than those of the other users are positioned together in closer proximity to his/her own flower than those of the other users. Alternatively, the more the user takes care of flowers of other users, the larger size those flower bloom in. The shape of each flower is also reflected, and the user can go to the Care screen from each flower.

Specific exemplary embodiments according to the present invention for realizing such user's experiences are explained hereinafter in detail with reference to the drawings. In a first exemplary embodiment, specific configurations and processes for realizing the generation of an image of the user's flower, and the projection or synchronization of user's psychological state (Sync) are explained. In a second exemplary embodiment, specific configurations and processes for realizing a psychological approach to or care (Care for) other users are explained. Further, specific configurations and processes for realizing a user list screen (View) and for realizing an advertisement model are explained in third and fourth exemplary embodiments, respectively. In a fifth exemplary embodiment, a configuration and a process for implementing a gift Seed function is explained. Finally, in a sixth exemplary embodiment, a configuration and a process for implementing a corporate account are explained.

### First Exemplary Embodiment

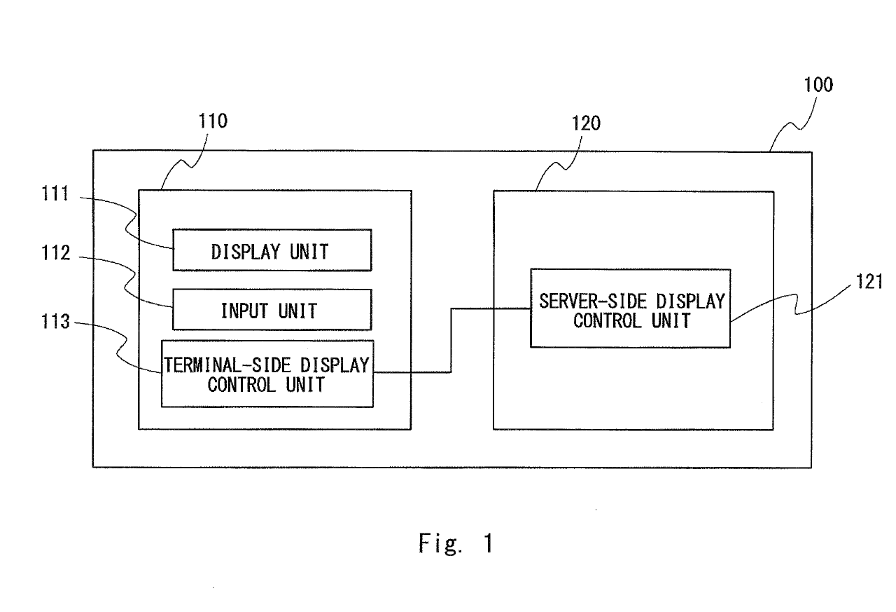

Firstly, a configuration of an information processing system 100 according to a first exemplary embodiment of the present invention is explained with reference to FIG. 1.

The information processing system 100 includes a user terminal 110 and a server 120. The user terminal 110 is connected to the server 120 through, for example, a communication network such as the Internet, a public network, a private line, and a mobile communication network so that the user terminal 110 communicates with the server 120. Note that only one user terminal 110 is shown in FIG. 1 for simplifying the explanation. However, a typical information processing system 100 includes a plurality of user terminals 110.

The user terminal 110 is an information processing apparatus including hardware components such as a storage device for storing a control program and the like, a control apparatus for executing various processes according to the control program, a communication apparatus for controlling communication with the server 120, an input device including a touch panel and various sensors, and an output device such as a display device and the like. Examples of the user terminal 110 include a mobile phone, a portable terminal (in particular, a smart phone), and a personal computer (PC).

The user terminal 110 includes a display unit 111, an input unit 112, and a terminal-side display control unit 113. These units are logical information processing units implemented by the above-described hardware and the control program.

The display unit 111 displays certain information under the control of the terminal-side display control unit 113. For example, the display unit 111 displays an image of a flower expressing the psychological state of the user himself/herself and/or flowers expressing the psychological states of other users.

The input unit 112 receives user's input indicating the psychological state of the user, an approach to (care for) other users, and so on. Examples of the input unit 112 includes a touch panel capable of receiving a drag action, a pinch action, and so on, and various sensors capable of detecting the inclination of the user terminal 110, light, an air current, and so on. Examples of such various sensors include an acceleration sensor, a gyroscopic sensor, an optical sensor, and an air-current sensor. Further, the input unit 112 may be a microphone or a camera. As described above, any given mechanism capable of detecting the user's action can be used as the input unit 112.

The terminal-side display control unit 113 makes the display unit 111 display certain information, e.g., an image of the flower(s) expressing the psychological state(s) of the user himself/herself and/or other users based on the user's input received by the display unit 111 and data and control information input from the server 120.

The server 120 is an information processing apparatus including hardware components such as a storage device for storing a control program and the like, a control apparatus for executing various processes according to the control program, and a communication apparatus for controlling communication with the user terminal 110. The server 120 is, for example, a server computer. However, the server 120 does not necessarily have to be a single apparatus and may be implemented by distributed processes performed by a plurality of apparatuses.

The server 120 includes a server-side display control unit 121. Note that the server-side display control unit 121 is a logical processing unit implemented by the above-described hardware and the control program.

The server-side display control unit 121 performs transmission/reception of parameters for displaying a flower image(s) expressing the psychological state(s) of the user himself/herself and/or other users between the user terminal 110 and the terminal-side display control unit 113, stores these parameters, and so on.

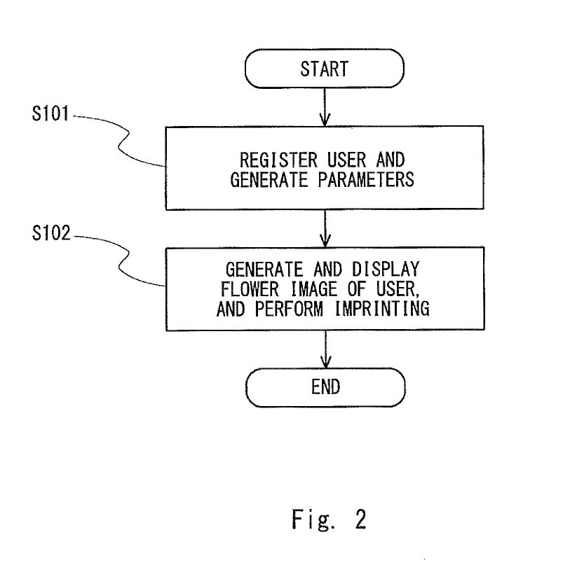

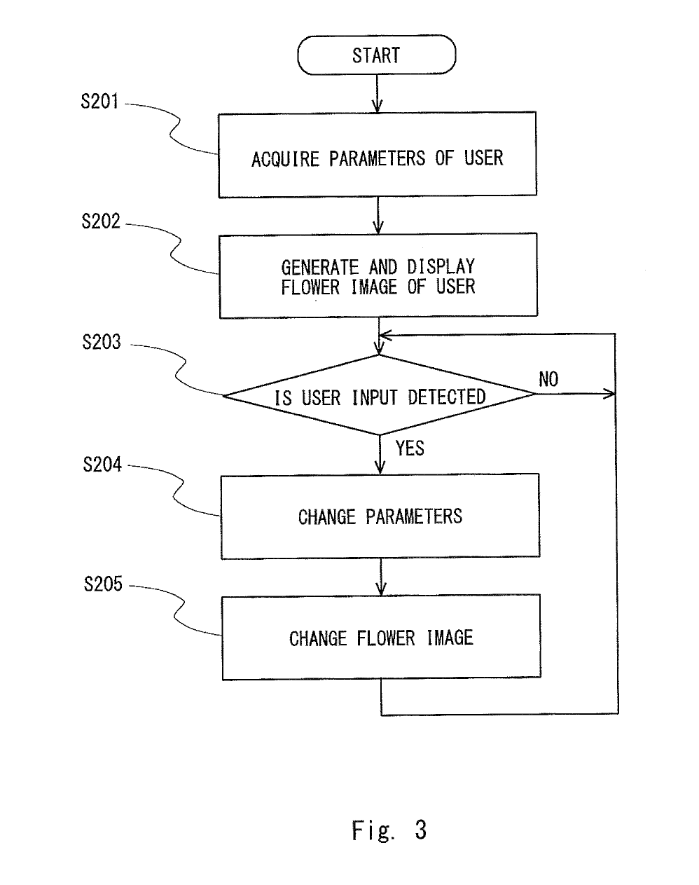

An operation of the information processing system 100 is explained hereinafter with reference to FIGS. 2 and 3.

### (Generation of User Flower Image)

FIG. 2 is a flowchart showing a series of processes in which when a given user starts to use the information processing system 100, the information processing system 100 generates a flower image of that user for the first time.

S101: The server-side display control unit 121 of the server 120 generates data for the user in response to an application by the user, and stores these data. Note that as a typical example, the application by the user may be a request to newly register a user account transmitted from the terminal-side display control unit 113 of the user terminal 110 to the server-side display control unit 121. Further, this request may include an identifier for uniquely specifying the user, the user terminal 110, or the terminal-side display control unit 113. When the server-side display control unit 121 receives the message, for example, the server-side display control unit 121 generates data for that user. Note that as the aforementioned data, the server-side display control unit preferably generate data (hereinafter also referred to as “first data”) for specifying the basic shape of the flower image corresponding to the user (e.g., the number of leaves and petals, a shape, a color, a size and so on), and data (hereinafter also referred to as “first parameter”) for specifying the shape state of that flower image (e.g., a posture, a color tone and so on). That is, the shape of the user's flower image is defined based on the basic shape specified by the first data and the shape state specified by the first parameter. The first data is, in a sense, the DNA of the user's flower. Therefore, unique values are preferably assigned to each user. In contrast to this, the value of the first parameter can be arbitrarily changed by the user as explained later. However, the server 120 can assign the initial values in this step. The server-side display control unit 121 associates these data with the aforementioned identifier and stores them in, for example, a storage area or the like (not shown).

### (Setting of User Identity)

Alternatively, the terminal-side display control unit 113 may provide a user identity setting screen (see fifth exemplary embodiment). The user identity means the color of the flower into which the user transforms and/or a melody representing the user. The user can arbitrarily set the color of the flower and/or the melody by using the user identity setting screen. The user identity set in this process is stored as part of the first data of the user's flower.

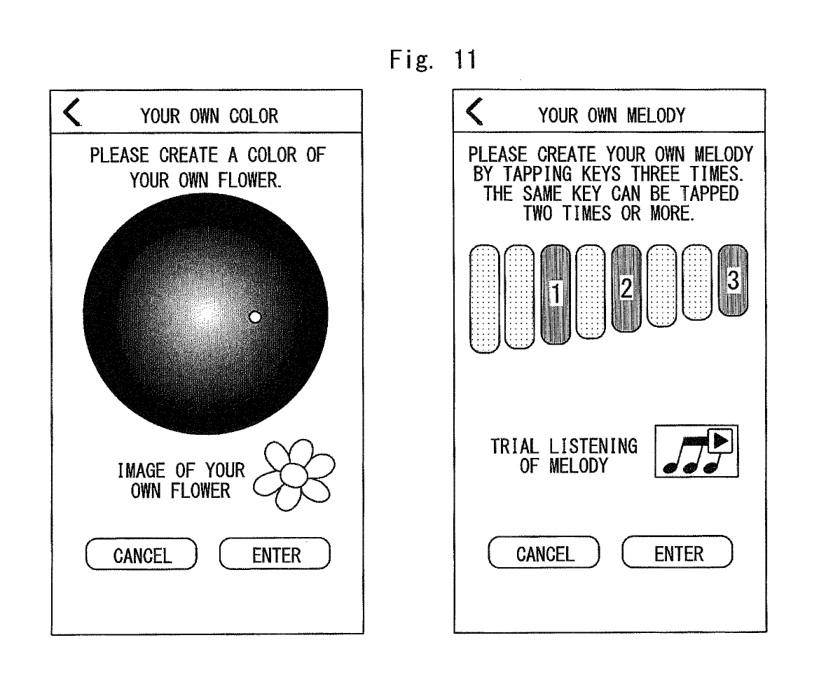

FIG. 11 shows an example of a user identity setting screen that the terminal-side display control unit 113 provides to a user. The left side is a color setting screen and the right side is a melody setting screen.

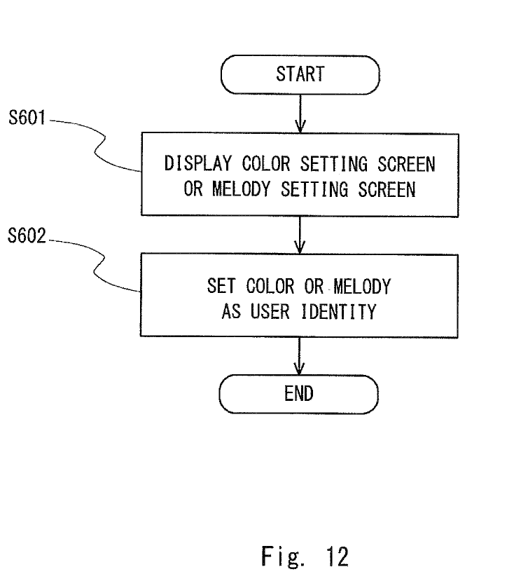

The user identity setting process that is performed by using the user identity screen is explained with reference to a flowchart shown in FIG. 12.

S601: the terminal-side display control unit 113 makes the display unit 111 display a color setting screen or a melody setting screen. For example, the terminal-side display control unit 113 displays these screens in response to a color setting or melody setting command performed by a user. As a typical example, an interface for starting the color setting or melody setting command can be provided as a part of the user profile setting function. Alternatively, the terminal-side display control unit 113 may display the color setting screen or the melody setting screen during the process through which a user acquires a new account.

S602: The terminal-side display control unit 113 receives color or melody setting through the color setting screen or the melody setting screen. For example, the terminal-side display control unit 113 can display a color chart (color wheel) like the one shown in FIG. 11 in the color setting screen, obtain color information corresponding to a place where the user has tapped on the color chart, and set this color information as the color of the user's flower. In this exemplary embodiment, the color specified in the color wheel by the user is reflected in the color of the petals of the flower image displayed in the same screen. Further, the terminal-side display control unit 113 can display a keyboard indicating a musical scale like the one shown in FIG. 11 in the melody setting screen, obtain information such as a musical scale(s) corresponding to a place(s) where the user has tapped on the keyboard within a predetermined period and a time(s) when the user has tapped on the keyboard, and set these information items as the user's melody. Note that the melody means a combination of a plurality of successive sounds each of which has a specific musical scale and a length. In this exemplary embodiment, a melody composed of three successive sounds can be defined as a user identity. Specifically, when the user selects a plurality of keys in succession, the color of the selected keys is changed and numbers indicating the selecting order are displayed on the keys. Further, when a predetermined number of keys (for example, three keys) are selected, the “enter” button becomes an active state. As a result, a melody can be determined. If necessary, a “trial-listening” button may be provided so that the user can confirm the melody before the melody is determined. The terminal-side display control unit 113 plays the melody that the user has entered through the keyboard in response to the pressing-down of the trial-listening button.

The terminal-side display control unit 113 detects, for example, that the user has pressed an enter button in the color setting screen or the melody setting screen, ties the user identity with the user in response to this detection, and stores the user identity in the tiled state in the server 120. The server 120 holds the user identity as the aforementioned first data.

S102: After the process in the step S101, the terminal-side display control unit 113 of the user terminal 110 acquires the first data and the first parameter from the server-side display control unit 121, generates a flower image according to these data, and makes the display unit 111 display the generated flower image. Note that when the flower image is displayed for the user for the first time or the like, the terminal-side display control unit 113 preferably devises some way of showing a situation in which the user himself/herself has transformed into this flower image (context), thereby enabling the user to understand this situation (imprinting).

The terminal-side display control unit 113 first displays, for example, an image of a seed and a message encouraging the user to touch the seed in the display unit 111. In this state, when the user touches the seed through the input unit 112, the terminal-side display control unit 113 makes the display unit 111 display an animation in which the shape of a heart or a ripple spreads from the touched point and wraps around the seed; the seed sprouts; branches and leaves grow; and a flower blooms. Note that the message encouraging the user to touch the seed may be displayed when the user enters no input for a predetermined time period after the image of the seed is displayed.

Alternatively, the terminal-side display control unit 113 activates a built-in camera (not shown) of the user terminal 110 and detects the face of the user in an image taken by the camera by using a publicly-known face detection technique. When the terminal-side display control unit 113 detects the face, the terminal-side display control unit 113 makes the display unit 111 display an animation in which a still image including the face converges on a flower seed on a background layer through an image effect such as a swirling effect; the seed into which the still image is sucked sprouts; branches and leaves grow; and a flower blooms.

### (Reflection of User's Psychological State)

FIG. 3 is a flowchart showing a series of processes in which the information processing system 100 reflects a user's psychological state in the shape state of a flower image (Sync).

S201: The terminal-side display control unit 113 of the user terminal 110 acquires the first data for specifying the basic shape of the flower image and the first parameter for specifying the shape state of this flower image from the server-side display control unit 121 of the server 120. The server 120 can identify the user who is supposed to be operating the user terminal 110 by using a publicly-known identification technique for identifying the user, the user terminal 110, the terminal-side display control unit 113, or the like, and hence can specify the first data and the first parameter that are stored in association with this user. Note that the first parameter acquired in this process is used as a value indicating the psychological state of the user after that.

In this exemplary embodiment, assume that the server-side display control unit 121 holds, as the first parameter, a posture parameter corresponding to the mood and/or the condition of the user and a color-tone parameter corresponding to the happiness and/or the fulfillment of the user. For example, when the user is cheerful in public places but is not enjoying his/her live from the bottom of his/her heart, the user can set the posture parameter to a high value and the color-tone parameter to a low value through user's input (which is explained later). Further, when the user is temporarily dejected due to a small mistake while he is deeply satisfied with his/her life on a daily basis, the user can set the posture parameter to a low value and the color-tone parameter to a high value. Materially speaking, these first parameters are numerical value data from 1 to 100. Further, greater values indicate a higher posture parameter and a higher color-tone parameter.

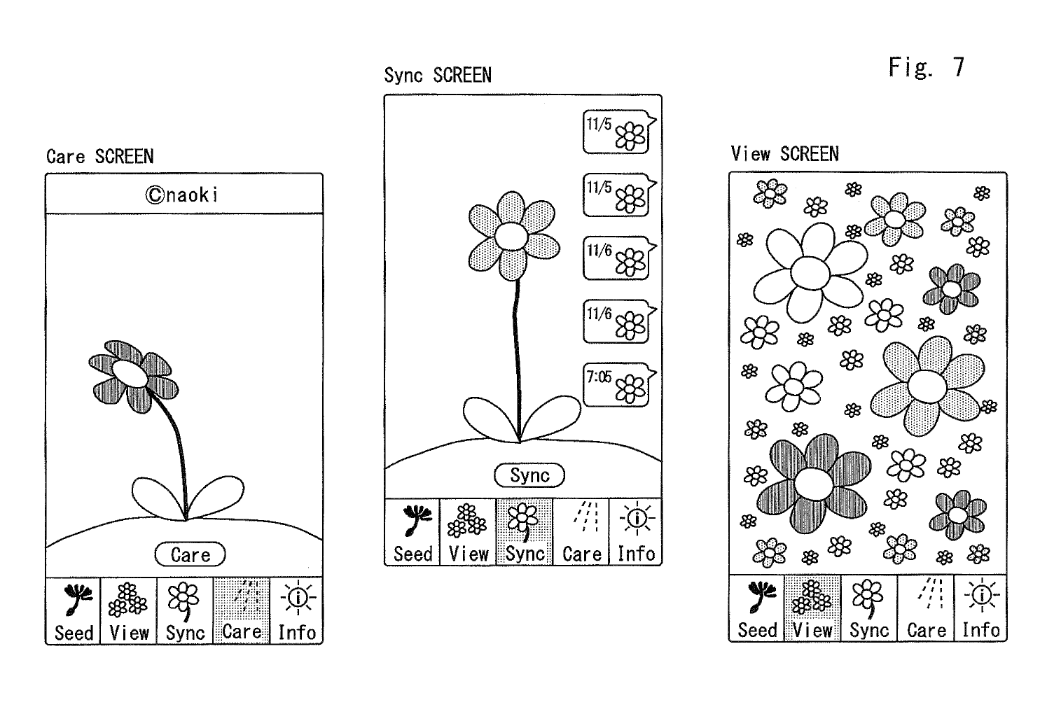

S202: The terminal-side display control unit 113 generates a flower image in which the psychological state of the user himself/herself is reflected based on the first data and the first parameter acquired in the step S201 (FIG. 7, Sync screen). Specifically, firstly, the number of leaves and petals, a shape, a color, a size and so on of the flower are determined according to the first data. Further, for example, the posture of the flower is determined according to the posture parameter, which is included in the first parameter, and the color tone of the flower is determined according to the color-tone parameter, which is also included in the first parameter. For example, the terminal-side display control unit 113 generates a flower image in such a manner that the higher the posture parameter is, the more widely the petals open and the straighter the stalk grows. On the other hand, the lower the posture parameter is, the more the petals close and the more the stalk withers. Further, for example, the terminal-side display control unit 113 generates a flower image in such a manner that the higher the color-tone parameter is, the higher the chrome of the flower image is and the lower the lightness of the flower image is. On the other hand, the lower the color-tone parameter is, the lower the chrome of the flower image is and the higher the lightness of the flower image is. The terminal-side display control unit 113 generates a flower image having both of these features specified by the first data and the first parameter.

Note that a relation between values for the first data and basic shapes of a flower, and a relation between values for the first parameter and shape states (posture, color tone) of a flower may be defined in a table (not shown) in advance. Alternatively, the number of leaves and petals, the shape, the color, the size, the posture, and the color tone may be calculated in accordance with a predetermined numerical formula that includes parameters as its elements or a predetermined algorithm. Further, a flower image to be generated may be selected from a plurality of pre-stored images. Alternatively, a flower image may be obtained by modifying a master image or a 3D model.

Note that when the color of a flower is defined as a user identity, the terminal-side display control unit 113 displays the flower image by using the color defined by the user. That is, the first data includes color information defined as a user identity. Further, when a melody is defined as a user identity, the terminal-side display control unit 113 can play that melody when the terminal-side display control unit 113 detects a touch on the flower image by the user.

S203: The input unit 112 detects an input entered by the user. For example, the input unit 112 detects a vertical drag action or a pinch in/out action performed on the touch panel by the user, and notifies the terminal-side display control unit 113 of the detection result. Preferably, the input unit 112 first detects that the user has pressed down a “Sync” button (FIG. 7), and then starts to detect the above-described input in response to the detection of the press-down. Alternatively, the server-side display control unit 121 detects that the user has performed a long press on the flower image, and start to detect the above-described input in response to the detection of the long-press.

S204: The terminal-side display control unit 113 changes the first parameter according to the detection result of the user's input obtained in the step S203. For example, when an upward or downward drag action is detected, the posture parameter is increased or decreased according to the detected amount of the drag action. Further, when a pinch in or pinch out action is detected, the color-tone parameter is decreased or increased according to the detected amount of the pinch action.

S205: Further, the terminal-side display control unit 113 generates a flower image having a shape state corresponding to the first parameter that has been changed in the step S204. That is, the shape state of the flower image is changed. For example, when the posture parameter is increased or decreased, the posture of the flower is increased or decreased. Further, when the color-tone parameter is increased or decreased, at least one of the chroma and the lightness of the flower is increased or decreased. Note that the process for changing the flower image may be carried out in parallel with the process for changing the first parameter performed in the step S204. After these processes, the input unit 112 continues to wait for the user's input (S203).

Further, when the terminal-side display control unit 113 makes the display unit 111 display the flower image of the user, the terminal-side display control unit 113 may make the display unit 111 display a ripple like a ripple on a water surface on the screen if a touch action on the input unit 112 is detected. In this way, it is possible to display the flower image artistically as a metaphor on a glassy water surface, i.e., as a mirror image of the user himself/herself.

Examples of the advantageous effects of this exemplary embodiment are described hereinafter.

According to this exemplary embodiment, each of the users who use the information processing system 100 can have a flower unique to that user in a virtual world. Further, the information processing system 100 performs imprinting for showing a context that this flower is an avatar of the user. As a result, the user has a sense of close affinity with his/her flower.

According to this exemplary embodiment, a user using the information processing system 100 registers a sensitivity property(s) such as the color and/or the melody of himself/herself through the user identity setting screen. In other words, the user registers internal property(s). This internal property(s) is fundamentally different from the ordinary profile registered as information. That is, this internal property(s) is an internal property(s) that is not actively unveiled under normal circumstances. In this exemplary embodiment, by registering such internal properties, the user can be lead so that the user sees the flower in terms of sensitivity rather than facing it as information when the user sees the flower for the first time. That is, because of this identity setting function, it is possible to perform imprinting for making the user feel a sense of close affinity for the flower more effectively.

Further, according to this exemplary embodiment, the user using the information processing system 100 performs a touch action through the input unit 112 for his/her flower displayed on the display unit 111, so that the shape state of the flower, whose first parameter has been changed, changes. Through this interface and the visual expression, the user has a spontaneous motivation that he/she wants to conform the shape state of the flower to his/her psychological state.

Further, according to this exemplary embodiment, the information processing system 100 can quantify the psychological unveiling, which is performed by the user based on his/her spontaneous motivation. Further, the information processing system 100 can store the quantified psychological unveiling and feedback the quantified psychological unveiling to the user.

### Second Exemplary Embodiment

In a second exemplary embodiment, a psychological approach to or care for (Care) other users is implemented as an additional function in the information processing system 100 according to the first exemplary embodiment. Note that the configuration of the information processing system 100 according to the second exemplary embodiment is similar to that of the first exemplary embodiment.

### (Psychological Approach to or Care for Other Users)

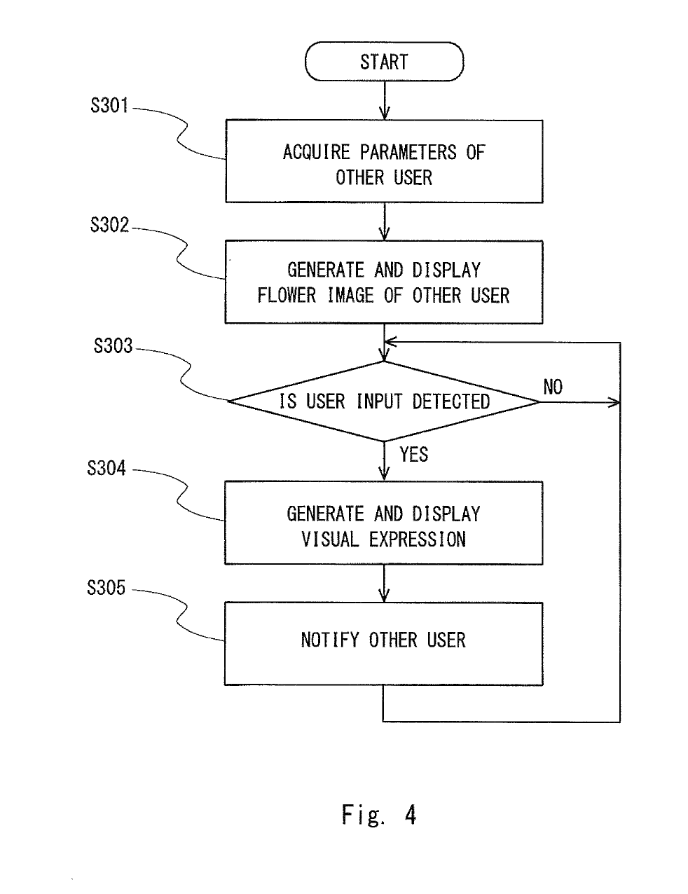

FIG. 4 is a flowchart showing a series of processes in which the information processing system 100 performs “Care” for a flower image(s) expressing the psychological state of another/other user(s).

S301: The terminal-side display control unit 113 of the user terminal 110 acquires data for specifying the basic shape (e.g., the number of leaves and petals, a shape, a color, a size and so on) of a flower image corresponding to another/other user(s) (hereinafter referred to as “second data”), and data for specifying the shape state (e.g., a posture, a color tone and so on) of the flower image of that another user(s) (hereinafter referred to as “second parameter”). Note that the input unit 112 preferably receives information for identifying another/other user(s) whom the terminal-side display control unit 113 should acquire the parameters for through user's input or the like in advance. For example, the input unit 112 can detect user's input for specifying another specific user (e.g., a touch action or a long press action on the flower of another user) from a View screen (which is explained later) displayed in the display unit 111 and notify the terminal-side display control unit 113 of the detection result.

S302: The terminal-side display control unit 113 generates a flower image in which the psychological state of the other user is reflected based on the second data and the second parameter acquired in the step S201 (FIG. 7, Care screen). The terminal-side display control unit 113 can generate the flower image through a process similar to that in the step S202 or play a melody according to an action performed on the flower image.

S303: The input unit 112 detects an input entered by the user. For example, the input unit 112 detects the angle of the user terminal 110 inclined by the user, the amount of light resulting from the user's action in which the user turns the user terminal 110 toward a light source (e.g., the sun), an air current generated when the user breathes on the user terminal 110, and so on by using an acceleration sensor, a gyroscopic sensor, an optical sensor, an air-current sensor, and so on. Alternatively, the input unit 112 may detect that the user turns the user terminal 110 toward a light source (e.g., the sun) by using a camera. In this case, the input unit 112 can detect that the camera is aimed at a light source (e.g., the sun) based on the brightness of a still image taken by the camera, the change in successive images, or the like. Further, the input unit 112 may detect that the user breathes on the user terminal 110 by using a microphone. In this case, the input unit 112 can detect that the user breathes on the microphone based on the wind noise obtained by the microphone. The input unit 112 notifies the terminal-side display control unit 113 of the detection result. Note that the detection of these user's inputs is preferably performed in response to a specific trigger event such as an event in which the user touches a “Care” button displayed in the display unit 111. Further, when the input unit 112 is in a state for receiving these user's inputs, the terminal-side display control unit 113 preferably notifies the user that the input unit 112 is in the user's input receiving state by, for example, changing the color of the “Care” button.

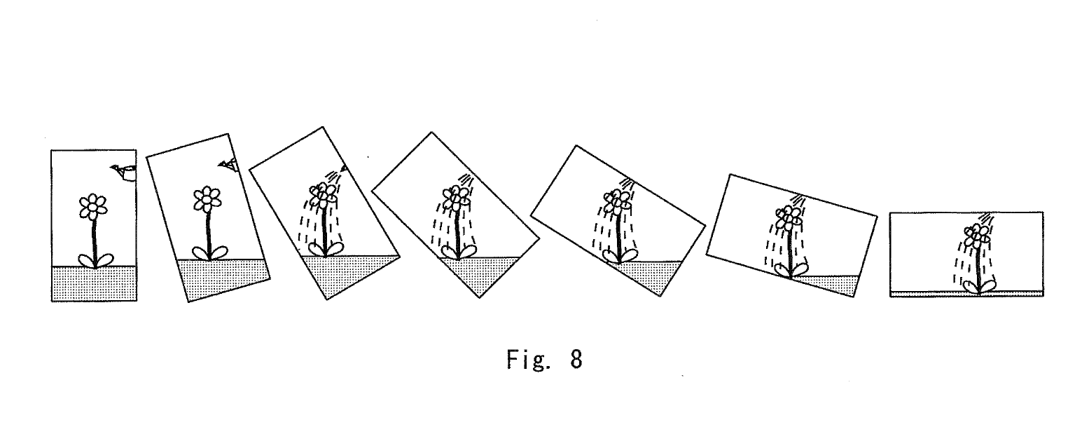

S304: The terminal-side display control unit 113 changes the visual expression relating to the flower image of the other user displayed in the display unit 111 according to the detection result of the user's input acquired in the step S303. For example, when an acceleration sensor or a gyroscopic sensor detects an inclination of the user terminal, the inclination of the watering pot displayed on the screen changes according to the detected inclination. As a result, an animation in which water is poured into the flower image of the other user is displayed. Alternatively, the inclination of the flower image itself is changed do that the horizontality in the screen coincides with the actual horizontality (FIG. 8). Further, the animation in which water is poured may be displayed when the detected inclination is within a predetermined range (for example, between 30 and 90 degrees). Further, when the inclination is not within that range, the animation may not be displayed.

Further, when an optical sensor, a camera, or the like detects light, sparkling sunshine is displayed above the flower image of the other user and a state where the color (or hue) of the flower image is changed and hence the flower becomes lively is displayed. Further, when an air-current sensor, a microphone, or the like detects an air current, an animation in which the flower image of the other user gently sways is displayed. Further, while these visual expressions are being displayed, a speaker or a vibrator may be driven and hence a chime or vibrations may be produced. When the outputs of these visual expressions are finished, the terminal-side display control unit 113 may display a message “Complete” or the like in the display unit 111, thereby notifying the user that the displaying of the visual expressions is finished.

S305: Further, the terminal-side display control unit 113 notifies the server-side display control unit 121 of the information indicating that Care has been given from the user to the aforementioned other user in order to notify the other user of the information. The server-side display control unit 121 associates the content of that notification with the identifier of the other user and stores it. Then, when the other user displays his/her flower image (S201 to S205), the server-side display control unit 121 can transmit the information indicating that Care has been given from the user to the other user at the same time as, for example, when the parameters are transmitted (S201). At this point, the terminal-side display control unit 113 of the user terminal 110 of the other user can display this information in the display unit 111 (FIG. 7, Sync screen). For example, when this information contains the name of the user who gave the Care, the time of the Care, the type of the Care, and so on, the terminal-side display control unit 113 can display a balloon including these information items near the flower image of the other user.

As a typical example, the terminal-side display control unit 113 displays a plurality of Cares to be sent in the time-series order. When all the balloons cannot be displayed in the Sync screen, the terminal-side display control unit 113 can display some of the balloons including the latest Care notification in the Sync screen and display the older balloons in response to a drag action or the like.

Note that the terminal-side display control unit 113 and the server-side display control unit 121 preferably do not use the Care given by the user as an element (or factor) for changing to the second parameter of the other user. That is, the Care given by the user should not be used for any purpose other than to notify the other user that the Care has been given.

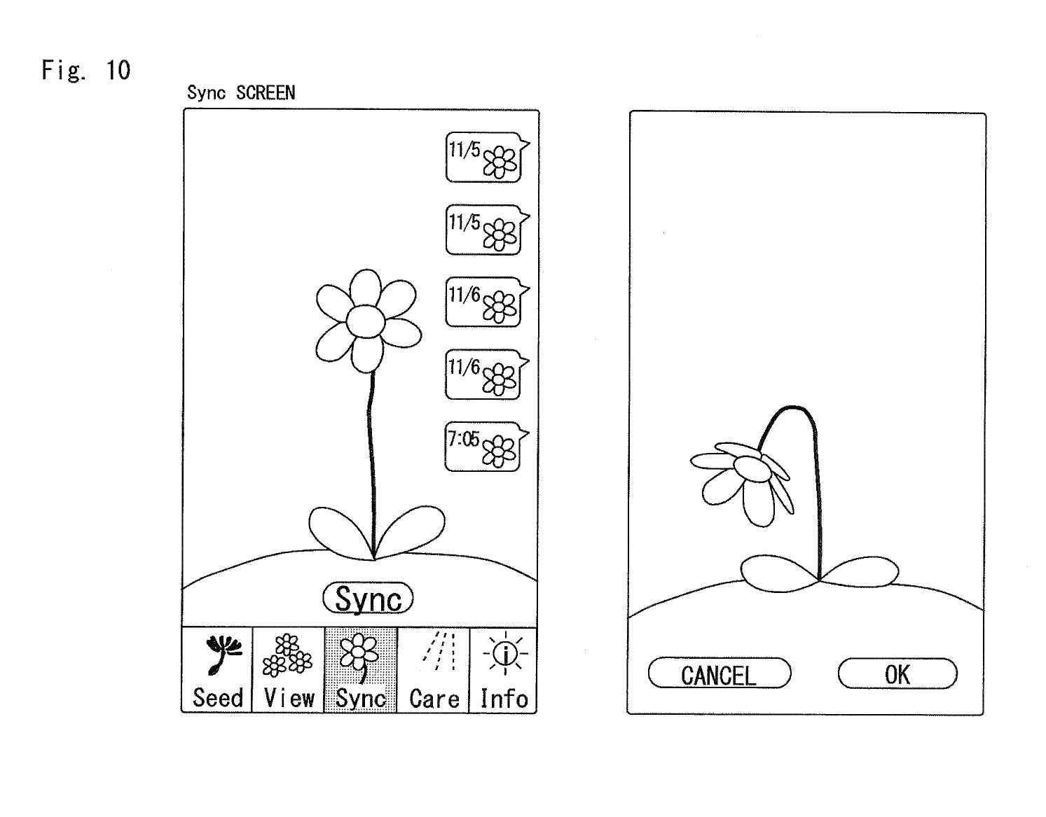

Alternatively, the terminal-side display control unit 113 may display only the flower image of the user who has performed a Care without displaying the user name of that user (FIG. 10). In this case, the terminal-side display control unit 113 can first display, for example, the image of the bud of the flower that has not bloomed yet within a balloon and, after a predetermined time, display the bloomed flower. Note that the time before the blooming may be randomly determined. Then, when the terminal-side display control unit 113 detects an action (such as a tap) for the bloomed flower image, the terminal-side display control unit 113 can play the user melody of the user who has transformed into that flower and performed the Care. In this way, the other user who has received the Care notification can feel and receive (i.e., find out) who has performed the Care based on the user melody based on the color of the flower and the melody. Further, when the terminal-side display control unit 113 detects a different action (such as a long press) for the bloomed flower image, the terminal-side display control unit 113 changes the screen to the Care screen of the user who has transformed into that flower and performed the Care. In this way, the other user who has received the Care can perform a Care for the user who has performed the Care.

Meanwhile, when the terminal-side display control unit 113 detects an action for the image of the flower that has not bloomed yet, the terminal-side display control unit 113 does not play the melody. In this case, the other user who has received the Care notification cannot immediately find who has performed the Care based. In this way, it is possible to prevent the other user who has received the Care from performing a Care to the user who has performed the Care in a knee-jerk manner.

Alternatively, the terminal-side display control unit 113 may perform simple control so that the other user who has received the Care cannot return a Care before a predetermined time has elapsed after receiving the Care. For example, this control may be implemented by making the Care button non-active so that the user cannot press down the Care button on the Care screen. In this way, it is possible to prevent any reflective (or automatic) action in return for the Care.

### (Subjective Affection Value)

Note that when a Care is performed for a user by another user, the terminal-side display control unit 113 or the server-side display control unit 121 can calculate a subjective affection value. The subjective affection value indicates a subjective affection level that a user embraces for another user, and is calculated according to, for example, the number of times for which the user refers to the flower image of the other user or performs Cares, its frequency, its elapsed time and the like. The calculated subjective affection value can be held by the terminal-side display control unit 113 or the server-side display control unit 121.

The subjective affection value can be set to, for example, a value between 1 and 100. Further, for the relation between the subjective affection value and the aforementioned number of times, the frequency, the elapsed time and the like, its correspondence relation may be defined in advance in a table (not shown). Alternatively, the subjective affection value may be calculated in accordance with a predetermined numerical formula that includes the aforementioned number of times, the frequency, the elapsed time and the like as its elements or a predetermined algorithm.

### (Anonymity Care)

Note that in the above-described example, the other user who has received the Care can recognize the user who has the Care. However, the server-side display control unit 121 and the terminal-side display control unit 113 may be configured so that information only the indicating that a Care has been performed is sent to the other user who has received the Care without sending any information about the user who has performed the Care to the other user.

In this case, in the step S305, the server-side display control unit 121 sends a notification including only the information indicating that the Care has been performed to the other user. This notification does not include any information capable of identifying the user who has performed the Care. Note that the terminal-side display control unit 113 of the user terminal 110 of the other user displays a balloon, such as a flower in a bud state, including no information about the user who has performed the Care in the display unit 111. Further, even when the terminal-side display control unit 113 detects an action for this balloon, the terminal-side display control unit 113 neither plays the melody nor changes the screens to the Care screen.

Examples of the advantageous effects of this exemplary embodiment are described hereinafter.

According to this exemplary embodiment, it is possible to see the flower(s) of another/other user(s) and to give various Cares to the flower of the other user through the input unit 112. Further, this Care is not used to change the second parameter of the other user. It is used only to notify the other user that the Care has been given. For the user, this Care is an experience of seeing the psychological state of the other user, and of learning that his/her psychological state can be seen by other users. Further, because of a feeling of wrongness that would be caused by lying about his/her psychological state to a valued person(s) and would be learned through this learning, the user has a spontaneous motivation that he/she wants to conform the shape state of the flower to his/her psychological state.

Further, according to this exemplary embodiment, the information processing system 100 can quantify the psychological unveiling, which is performed by the user based on his/her spontaneous motivation, and convey the quantified psychological unveiling to other people.

Further, according to this exemplary embodiment, the user cannot immediately perform any action in return for the Care, which has been performed for the user himself/herself, for the other user who has performed that Care through the Care notification. As a result, it is possible to prevent any superficial and/or perfunctory Care and thereby to facilitate more essential psychological exchanges.

Further, according to this exemplary embodiment, the only information that needs to be transmitted/received between the user terminal 110 and the server 120 in order to perform the projection (or synchronization) of the user's psychological state and the Care for other users is the parameter(s) and the notification(s). That is, in the conventional communication using physical information, it is usually necessary to transmit a large amount of information. In contrast to this, in this exemplary embodiment, a psychological exchange is performed by using an extremely small amount of information. In other words, the user needs to make a certain effort in order to send the minimized information. That is, the sender concentrates his/her feeling on a symbolic effort and transmits/receives that symbolic effort, so that the receiver can imagine the sender's feeling from that symbolic effort. In this way, it is possible to realize a psychological exchange medium that cannot be realized by any information sharing medium in the past.

### Third Exemplary Embodiment

In a third exemplary embodiment, a View screen displaying a list view of the user and other users is implemented as an additional screen in the information processing system 100 according to the first and second exemplary embodiments. Note that the configuration of the information processing system 100 according to the third exemplary embodiment is similar to that of the first exemplary embodiment.

### (List View of Users)

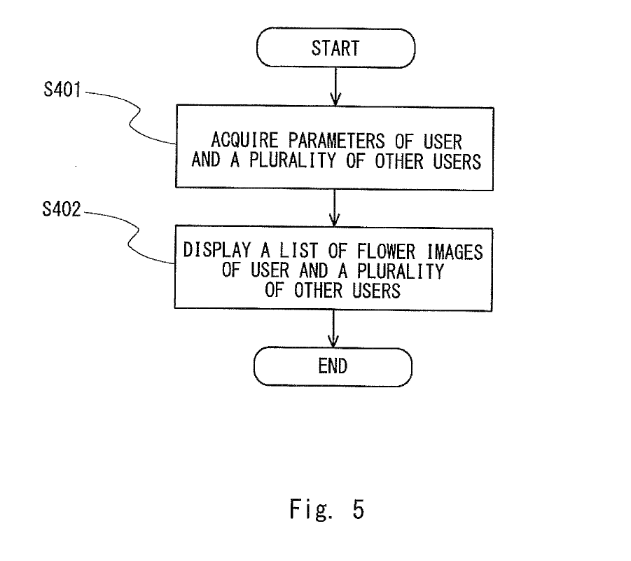

FIG. 5 is a flowchart showing a series of processes in which the information processing system 100 makes the display unit 111 display a View screen displaying a list view of the user and other users.

S401: The terminal-side display control unit 113 of the user terminal 110 acquires the first data and the first parameter of the user and the second data and the second parameter of each of the plurality of other users from the server-side display control unit 121 of the server 120.

S402: The terminal-side display control unit 113 generates a flower image for each of the users and the plurality of other users based on the information acquired in the step S401. The terminal-side display control unit 113 can generate these flower images through a process similar to that in the step S202. Further, the terminal-side display control unit 113 displays these flower images in the display area of the display unit 111 in a list-view fashion (FIG. 7, View screen).

For example, the terminal-side display control unit 113 generates a list-view display screen in which the flower image of the user is positioned at the center of the flower images of the other users arranged around the user's flower image in a radial pattern. Note that the distances between the user's flower image and those of the other users and the sizes of the flower images of the other users can be adjusted according to the subjective affection value of the user for those other users. That is, the distances and the sizes of the other users can be adjusted in such a manner that the higher the subjective affection value for another user is, the shorter the distance between the user's flower image and that of the other user's flower image becomes and the larger the size of that other user becomes.

Further, when all the other users cannot be displayed in one display area, the terminal-side display control unit 113 may perform control so that some of the other users that are located outside the aforementioned display area can be displayed by scrolling the screen. Further, the terminal-side display control unit 113 may display a simplified map in the display area as desired so that the user can recognize the rough position of the display area in the whole area.

Further, the View screen may include a search box where a keyword(s) for searching for other users (e.g., user's name) is entered. The terminal-side display control unit 113 transmits the keyword entered in that search box to the server-side display control unit 121. The server-side display control unit 121 searches for a user(s) corresponding to that keyword from information for other users held by the server 120 by using a publicly-known search technique, and transmits the search result to the terminal-side display control unit 113. The terminal-side display control unit 113 can display the View screen in such a manner that the flower image of a user included in the search result is positioned at the center of the flower images of a plurality of other users.

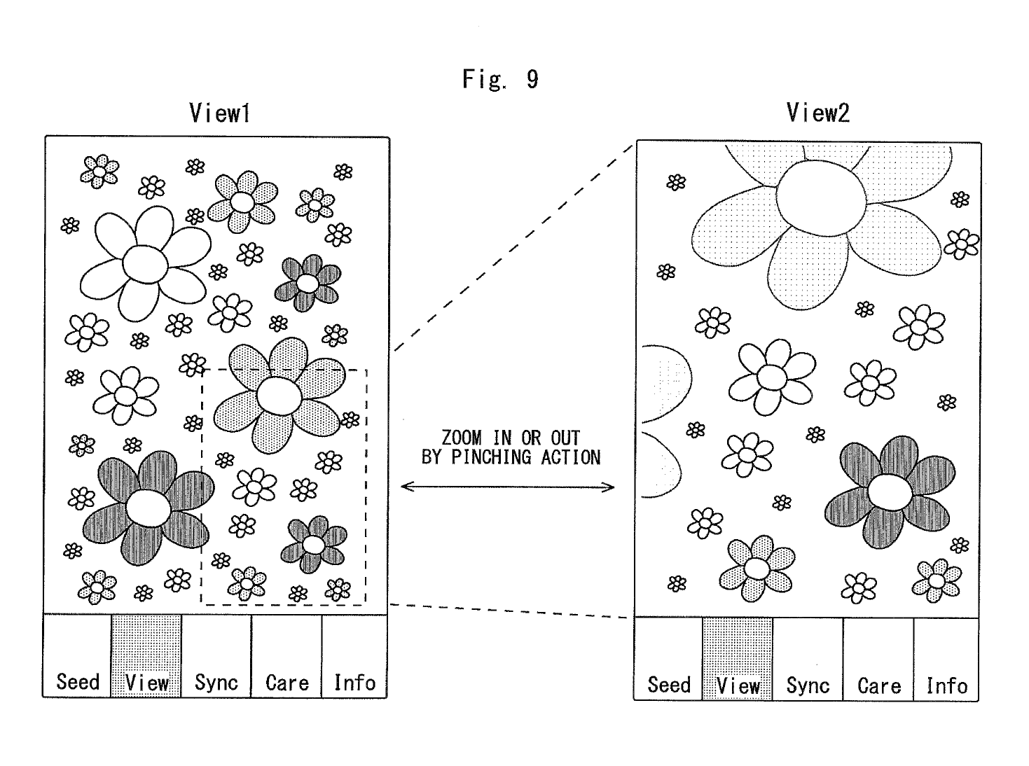

Alternatively, the terminal-side display control unit 113 may generate a list-view display screen in which the flower images of the other users are disposed all over the screen (FIG. 9, View 1). Note that the sizes of the flower images of the other users can be adjusted according to the above-described the user's subjective subjective affection values for those other users. That is, the terminal-side display control unit 113 can display the list-view display screen in such a manner that the larger the subjective affection value for the other user is, the larger the his/her flower image becomes and that the smaller the subjective affection value for the other user is, the smaller the his/her flower image becomes. A plurality of levels may be defined for the flower sizes, and flower images having appropriate sizes may be selected according to the subjective affection value. For example, when the subjective affection value can be set to one of ten levels from 1 (lowest) to 10 (highest) and there are five levels from 1 (lowest) to 5 (highest) for the flower sizes, the terminal-side display control unit 113 may assign flower sizes 1 to 5 to the flower images of the other users whose subjective affection values are in the highest five levels (from 6 to 10) and display the flower images in the assigned sizes. That is, the terminal-side display control unit 113 displays the flower image of other users whose subjective affection value is 10 in the size 5 and displays the flower image of other users whose subjective affection value is 6 in the size 1. The other users whose subjective affection value is 5 or less are not displayed in the screen at this stage. The terminal-side display control unit 113 preferably arranges the plurality of flower images having a plurality of sizes in the screen in such a manner that they are not overlapped each other and they are uniformed arranged over the screen. When all the flower images cannot be displayed in the display area of the View screen, the terminal-side display control unit 113 can display some of these flower images in the display area and display the remaining flower images in the display area in response to a drag action or the like performed on the View screen by the user.

Further, the terminal-side display control unit 113 preferably zooms in or out the View screen in response to a pinch action performed on the View screen by the user (FIG. 9, View 2). For example, the terminal-side display control unit 113 zooms in a part of the View screen so that the sizes of the displayed flower images increases by one level in response to a pinch-out action performed on the View screen. In this process, the flowers that have already had the maximum size are displayed in a translucent fashion. Further, among the flowers that were not displayed until now, the flowers of the other users having the highest subjective affection value (the other users whose subjective affection value is five in the above-described example) are newly displayed as flowers having the minimum size. Note that when the number of the other users whose flower images are newly displayed in the minimum size is so large that all of those flower images cannot be contained in the View screen, some of these other users can be randomly selected so that all of their flower images can be displayed. Similarly, the terminal-side display control unit 113 zooms out the View screen so that the sizes of the displayed flower images decreases by one level in response to a pinch-in action performed on the View screen. In this process, the flowers that have been displayed with the minimum size until now are not displayed anymore. Further, among the flowers that have been displayed in a translucent fashion, the flowers of the other users having the lowest subjective affection value are displayed in a non-translucent fashion. Even when the terminal-side display control unit 113 zooms in or out, the terminal-side display control unit 113 displays the plurality of flower images having a plurality of sizes in such a manner that they are not overlapped each other and they are uniformed arranged over the screen. In other words, even when the terminal-side display control unit 113 zooms in or out, the terminal-side display control unit 113 draws those flowers in a fractal fashion so that the arrangement/balance of the flowers displayed on the View screen is unchanged.

Note that when the terminal-side display control unit 113 generates the View screen shown in FIG. 9, the terminal-side display control unit 113 does not need to acquire the first data and the first parameter of the user himself/herself in the step S401. Further, in this case, the terminal-side display control unit 113 may acquire only the second data of the other user and may not reflect the psychological state of the other user for the flower image of the other user. That is, the terminal-side display control unit 113 may display the flower image in a shape in which the second parameter is not reflected.

Regardless of the form of the View screen, the terminal-side display control unit 113 can changes the View screen to the Care screen of a given flower image when the terminal-side display control unit 113 detects a predetermined action, such as a touch action and a long press action, performed on that flower image. Alternatively, when the terminal-side display control unit 113 detects a first action (e.g., a touch action) for a given flower, the terminal-side display control unit 113 plays the melody (which is explained later) of the other user who has transformed into that flower. Further, when the terminal-side display control unit 113 detects a second action (e.g., a long press action) for a given flower, the terminal-side display control unit 113 changes the screen to the Care screen for that flower. That is, the terminal-side display control unit 113 may perform different operations according to the type of the action.

According to this exemplary embodiment, the user can display his/her flower at the center of the flowers of a plurality of other users in a list-view fashion according to the subjective affection value. As a result, there is no need for operations for registering friends and the like. Further, it is possible to make it easy to give Cares to other users even further when the user feels closer intimacy for the users. Further, since a mental image scene is visualized, it is possible to make a user to have such an internal motivation that he/she wants to correct the gap between the intimacy that the user actually feels and the intimacy displayed on the View screen.

### Fourth Exemplary Embodiment

In a fourth exemplary embodiment, an advertisement model using the information processing system 100 according to the first to third exemplary embodiments is implemented. Note that the configuration of the information processing system 100 according to the fourth exemplary embodiment is similar to that of the first exemplary embodiment.

### (Advertisement Model)

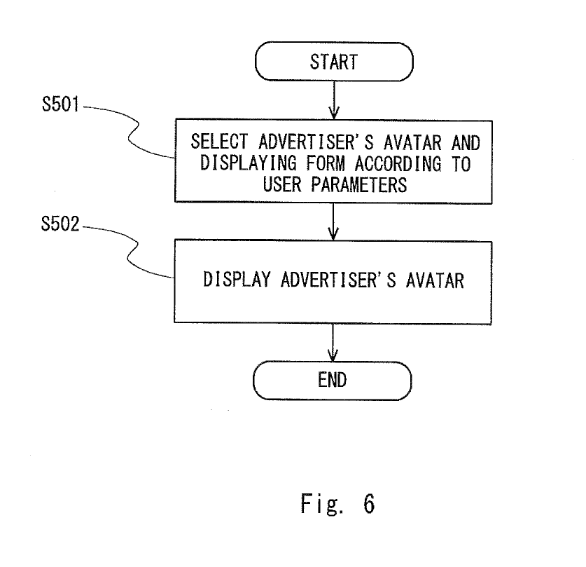

FIG. 6 is a flowchart showing a series of processes in which an advertiser perform an advertise representation for a user(s) in the information processing system 100.

S501: The server-side display control unit 121 of the server 120 refers to the first parameter of the user and selects an appropriate advertise representation according to the first parameter. The advertising representation in this specification may be, for example, an avatar and a shape state of the avatar that are prepared in advance in association with the first parameter by the advertiser. Specifically, when the posture parameter of the user is lower than a predetermined threshold, a kind-looking avatar and an animation in which that avatar comforts the user's flower are selected. Further, when the color-tone parameter of the user is higher than a predetermined threshold, a pleasant-looking avatar and an animation in which that avatar dances around the user's flower are selected. The relation between the first parameter of the user and the avatars of the advertiser and their shape states may be defined in, for example, a table (not shown) in advance.

Note that the advertising representation, in particular, the avatar of the advertiser preferably, does not have a form that includes a lot of information items for fueling demand, such as product information, brand information, and company information as seen in the conventional targeting advertisements. Instead, the advertising representation does not include any information for fueling demands or does have the minimum information that makes it possible to identify the advertiser. Further, the avatar is preferably formed so that it performs only communication actions psychologically contributing to the flower of a user(s).

Further, in the conventional targeting advertisements, the trends for demand are analyzed based on the profiles and behaviors of users and business owners selectively deliver advertisements that fit the trends. However, an avatar of an advertisement according to this exemplary embodiment is preferably prepared entirely according to the requests from the advertiser without taking the demand trends and the like into consideration. Further, a plurality of types of advertisements are preferably prepared for one advertiser and an advertisement(s) of the type which contributes the most is preferably delivered according to the psychological state of a user(s) at the time of the delivery.

The server-side display control unit 121 generates a screen display element(s), e.g., an animation file, including a selected avatar and a shape state, and transmits the generated screen display element to the terminal-side display control unit 113.

S502: The terminal-side display control unit 113 of the user terminal 110 receives the screen display element generated in the step S501 from the server-side display control unit 121, and makes the display unit 111 display the screen display element. The terminal-side display control unit 113 can display the above-described screen display element at an appropriate timing in an appropriate position when, for example, the user is displaying the Sync screen (S201 to S205).

Examples of the advantageous effects of this exemplary embodiment are described hereinafter.

According to this exemplary embodiment, an advertising representation, e.g., an avatar of an advertiser that matches the first parameter of the user, i.e., the quantified psychological state of the user; that is, an avatar of an advertiser capable of performing a psychologically contributing action(s) for the user is selected. As a result, the advertiser can establish rapport (psychological synchronization) between the advertiser and the user. In the conventional advertisements, it is impossible to demolish the fundamental confrontational relation between advertisers who “want to sell products” and users who “do not want to be forced to buy products” regardless of what kind of communication the advertisers attempt with “business” interposed therebetween. In contrast to this, this exemplary embodiment can realize communication in which “business” is not interposed between the advertiser and user. As a result, it can be expected to produce an advantageous effect that, when an actual demand occurs, the advertiser is selected.

### Fifth Exemplary Embodiment

In a fifth exemplary embodiment, a gift Seed function is implemented in the information processing system 100 according to the first to fourth exemplary embodiments. Note that the configuration of the information processing system 100 according to the fifth exemplary embodiment is similar to that of the first exemplary embodiment.

### (Gift Seed Function)

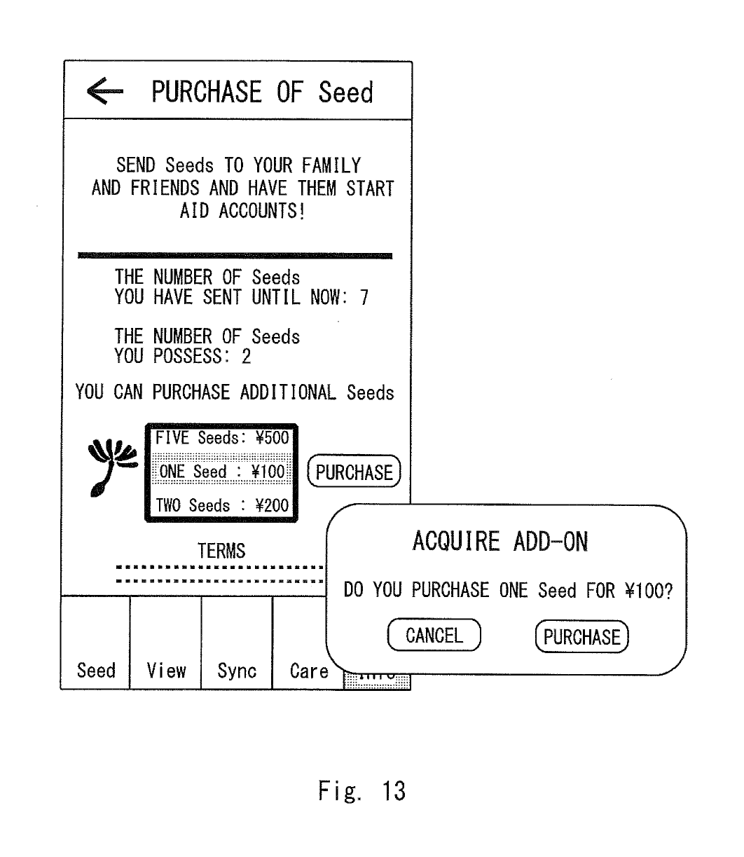

A user can purchase a Seed by using a Seed purchase screen shown in FIG. 13 and give it to another user (such as a member of the family, a friend, and so on). Then, the user who has received the Seed can acquire a pay account (which is described later) by using that Seed without buying it by himself/herself.

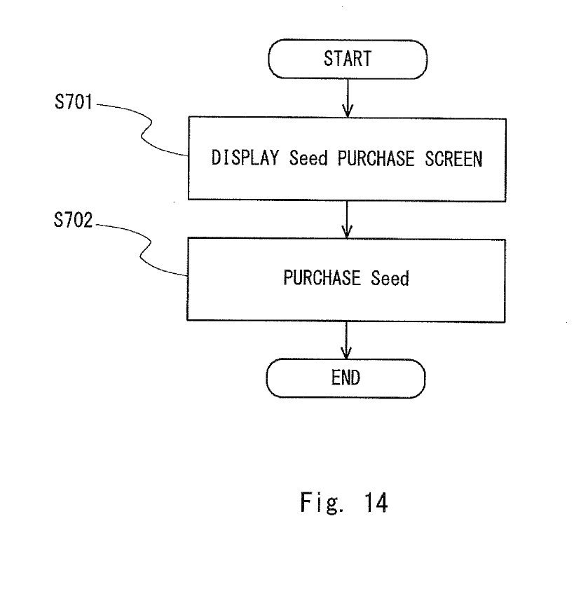

FIG. 14 is a flowchart showing a process through which a user purchases a Seed.

S701: The terminal-side display control unit 113 makes the display unit 111 display a Seed purchase screen shown in FIG. 13. For example, the terminal-side display control unit 113 displays this screen in response to a Seed purchase command performed by a user. As a typical example, an interface for starting the Seed purchase command can be provided as a part of the user profile setting function.

S702: The terminal-side display control unit 113 receives the number of Seeds the user wants to purchase through the Seed purchase screen. For example, the terminal-side display control unit 113 displays a select list shown in FIG. 11 so that the user can select the number of Seeds.

The terminal-side display control unit 113 detects, for example, that the user has pressed an enter button, ties the purchased Seed(s) with the user in response to this detection, and stores the purchased Seed(s) in the tiled state in the server 120. Further, the server 120 can charge the user the price of the Seed(s) by using a known billing technology.

### (Transmission of Seed)

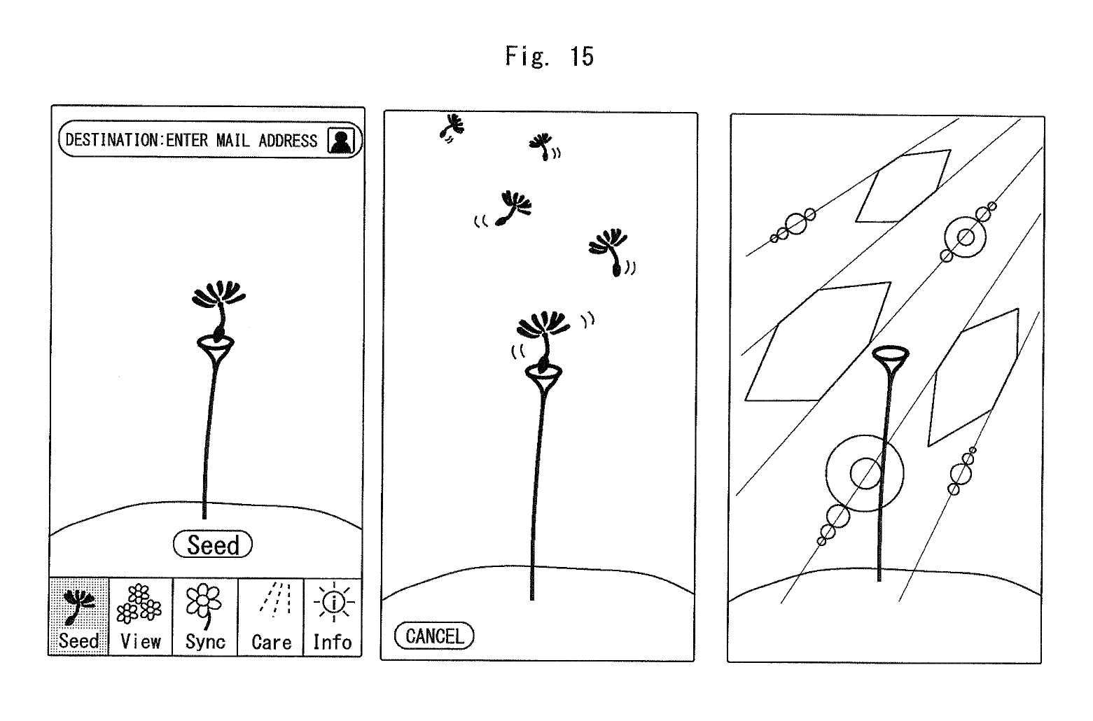

The user can transmit purchased Seed(s) to another user (such as a member of the family, a friend, and so on) by using a Seed transmission screen shown in FIG. 15.

FIG. 8F is a flowchart showing a process through which a user transmits a Seed.

S801: The terminal-side display control unit 113 makes the display unit 111 display the Seed transmission screen shown. The Seed transmission screen includes an interface through which the user enters the transmission destination of a Seed. For example, the display unit 111 includes an input box in which the email address of the transmission destination is entered. For example, the terminal-side display control unit 113 displays this screen in response to a Seed transmission command performed by a user. As a typical example, an interface for starting the Seed transmission command can be provided as a part of the user profile setting function. Further, the terminal-side display control unit 113 permits only users who have at least one purchased Seed to perform this Seed transmission command.

S802: The terminal-side display control unit 113 detects, for example, that the user has pressed a Seed button and transmits the Seed to the transmission destination received through the Seed transmission screen. As a typical example, the terminal-side display control unit 113 transmits an email indicating a code number uniquely indicating the Seed to the received email address. Alternatively, the terminal-side display control unit 113 detects a user's action of breathing on a seed (fluff) displayed on the screen by detecting the wind noise received by the microphone, and performs the above-described transmission operation in response to this detection. In this process, the terminal-side display control unit 113 may shows the user that the Seed is transmitted by making the display unit 111 display an animation in which the seed (fluff) flies away.

The user who has received the Seed can acquire a pay account through, for example, a pay account acquisition screen (not shown) provided by the terminal-side display control unit 113. As a typical example, when the information processing system 100 receives a code number uniquely indicating a Seed or the like when the information processing system 100 creates a new user account, the information processing system 100 provides a pay account to that user. Preferably, the information processing system 100 equally handles a pay account acquired by using the Seed as described above and a pay account purchased by the user himself/herself.

### (Pay Account)

A pay account is a pay account that an individual user can purchase in the system according to the present invention. The terminal-side display control unit 113 performs control for users having pay accounts so that user experiences having higher quality are provided to the user. Examples of such higher quality experiences include providing a gift Seed function and/or an anonymity Care function and preventing banner advertisements from being displayed in the display unit 111. Meanwhile, for users having ordinary accounts, the terminal-side display control unit 113 performs control so that, for example, the Seed function and/or the anonymity Care function is not provided and banner advertisements are displayed in the display unit 111.

According to this exemplary embodiment, a user can present a Seed to other users by using the gift Seed function. Therefore, it is possible to provide an opportunity in which a user can feel happiness by contributing to others. Further, the information processing system 100 can provide an experience having higher quality to the user to whom the Seed is sent and thereby improve the satisfaction of the user. Further, the information processing system 100 can obtain profits by charging the user for the gift Seed function.

### Sixth Exemplary Embodiment

In a sixth exemplary embodiment, a corporate account is implemented as an additional function in the information processing system 100 according to the first to fourth exemplary embodiments. Note that the configuration of the information processing system 100 according to the sixth exemplary embodiment is similar to that of the first exemplary embodiment.

### (Corporate Account)

Since the main purpose of the information processing system 100 is psychological exchanges among people, individual users have accounts in the information processing system 100. In contrast to this, in corporate accounts, organizations such as companies have accounts in the information processing system 100.

In this exemplary embodiment, one corporate account has an active group and a passive group. As a typical example, exiting user accounts of individual members of the organization such as employees of the company are registered in the active group. On the other hand, exiting users accounts of individual users who are supposed to receive psychological exchanges from the users of the active group, such as customers of the company, are registered in the passive group. For example, the company or the like collects information of user accounts which are a prospective target by a campaign or the like and creates a passive group based on the user account information.

Users in the active group can perform Cares for users in the passive group. However, users in the active group cannot specify users in the passive group for which the Cares are performed. That is, the information processing system 100 automatically assigns users in the passive group for which the Cares are performed.

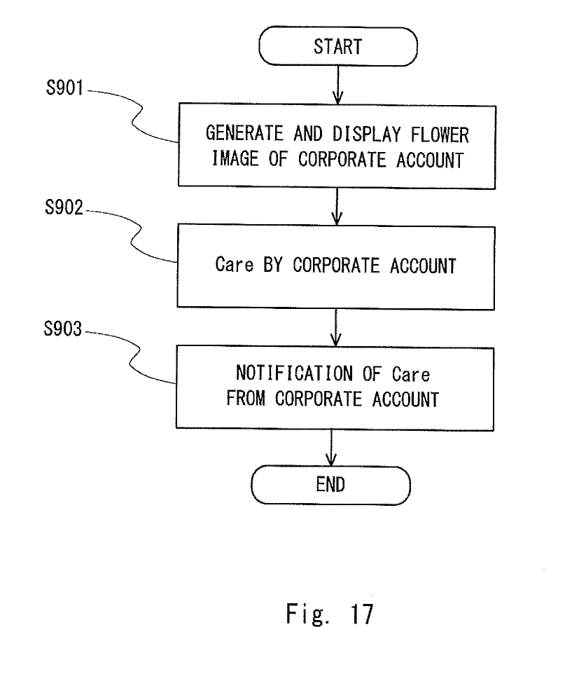

FIG. 17 shows a flowchart of a process relating to the corporate account. Note that the operations relating to the View screen and the Care screen are similar to those for the user accounts, unless otherwise specified.

S901: The terminal-side display control unit 113 displays a flower image indicating the passive group on the View screen and the Care screen of a user of the active group. Basically, this flower image represents the passible group as a group and does not include any information capable of identifying an individual user included in the passive group.

Alternatively, the terminal-side display control unit 113 can display, as the above-described flower image, the flower of a user(s) belonging to the passive group that the information processing system 100 automatically assigns as the target(s) of the above-described Care. A user identity (such as a color and a melody) may be given to this flower image. However, even in this case, the user name of any user included in the passive group is preferably not displayed together with the flower image.

S902: The terminal-side display control unit 113 receives a Care action to the flower image representing the passive group performed by a user of the active group.

S903: The server-side display control unit 121 selects an arbitrary user(s) from among the users included in the passive group and processes the Care action received in the step S902 as an action for the selected user. That is, the selected user receives the Care action of the step S902. In this process, the server-side display control unit 121 notifies the selected user of this Care action as an action performed by the active group. That is, the transmission source information, which is displayed in a balloon notifying the selected user of the Care, indicates only the active group as a group and does not include any information capable of identifying an individual user included in the passive group.

Alternatively, the terminal-side display control unit 113 may add an identity (such as a color and a melody) of a user(s) included in the passive group who has actually performed the Care to the balloon notifying the selected user of the Care. However, even in this case, the user name of the user(s) included in the passive group is preferably not displayed in the balloon.

Note that the information processing system 100 may bill an organization(s) using a corporate account(s) by using a known billing technology.

Further, the information processing system 100 may operate so as receive a Care that is provided from a user belonging to a passive group to a user belonging to an active group. In this case, the information processing system 100 performs the operations from the step S901 to the step S903 in a state where the active group and the passive group are interchanged. That is, the terminal-side display control unit 113 displays a flower image indicating the active group or the flower image of an arbitrary user in the active group on the View screen and the Care screen of a user in the passive group. Next, the terminal-side display control unit 113 receives a Care action for the flower image of the active group performed by the user in the passive group. Then, the server-side display control unit 121 processes this Care action as an action for the arbitrary user included in the active group.

According to this exemplary embodiment, a user(s) in an active group in a corporate account can perform a Care to a user(s) in a passive group without identifying specific individuals each other. In this way, each individual member of an organization can have an experience in which that member makes an approach to a user(s) in behalf of the organization. As a result, it is possible to make members of the organization have an excellent mind state such as a customer-oriented mind state.

### Other Exemplary Embodiments

Further, the present invention is not limited to the above-described exemplary embodiments, and needless to say, various modifications can be made without departing from the spirit and scope of the present invention.

For example, examples in which the terminal-side display control unit 113 generates the flower images or the like of the user and the other users are shown in the above-described exemplary embodiments. However, the server-side display control unit 121 may generate the flower images or the like of the user and the other users and then transmit screen display elements for displaying these flower images or the like to the terminal-side display control unit 113.

Further, although the above-described exemplary embodiments are explained on the assumption that the information processing system 100 has both the Sync function and the Care function, the present invention is not limited to this configuration. For example, the information processing system 100 may have the Care function without having the Sync function. Even in this case, a group of functions that are operated on the premise of the Care function, such as the gift Seed function and the corporate account function as well as the Care function itself, can be operated as in the case of the above-described exemplary embodiments. Further, the advantageous effect that psychological exchanges among users can be performed can also be obtained, though it is unrelated to the psychological conditions of the persons to which the users perform the psychological exchanges. Alternatively, the information processing system 100 may have the Sync function without having the Care function. Even in this case, there is an advantageous effect that the user can regard the flower as his/her psychological condition, synchronize with the flower, and record, manage and share the flower. Although the Sync function and the Care function can be independently established, a higher synergistic effect can be obtained when they are both provided. If there is the Sync function, the transformation of the user himself/herself into the flower becomes deeper. Further, the psychological states are visualized and the Cares among users are thereby facilitated. Further, if there is the Care function, it serves as a proper stimulus, thus preventing the internal completion. Further, because of the feeling that the user does not want to lie about his heart to the other intimate user, the motivation for the Sync also increases.

Although the present invention is described mainly as a hardware configuration in the above-described exemplary embodiments, the present invention is not limited to the hardware configurations. Further, arbitrary processing can be logically implemented by causing a CPU (Central Processing Unit) to execute a computer program. In such cases, the computer program can be stored in various types of non-transitory computer readable media and thereby supplied to computers. The non-transitory computer readable media includes various types of tangible storage media. Examples of the non-transitory computer readable media include a magnetic recording medium (such as a flexible disk, a magnetic tape, and a hard disk drive), a magneto-optic recording medium (such as a magneto-optic disk), a CD-ROM (Read Only Memory), a CD-R, and a CD-R/W, and a semiconductor memory (such as a mask ROM, a PROM (Programmable ROM), an EPROM (Erasable PROM), a flash ROM, and a RAM (Random Access Memory)). Further, the program can be supplied to computers by using various types of transitory computer readable media. Examples of the transitory computer readable media include an electrical signal, an optical signal, and an electromagnetic wave. The transitory computer readable media can be used to supply programs to computer through a wire communication path such as an electrical wire and an optical fiber, or wireless communication path.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A user terminal comprising:
a terminal-side display control unit that generates a first flower image corresponding to a first user;
a display unit that displays an image generated by the terminal-side display control unit; and
an input unit that receives a first input operation by the first user, wherein
the terminal-side display control unit changes the first flower image according to the first input operation.

2. The user terminal according to claim 1, wherein the terminal-side display control unit generates the first flower image by a combination of a basic shape corresponding to first data and a shape state corresponding to a first parameter.

3. The user terminal according to claim 2, wherein the terminal-side display control unit:
changes the first parameter according to the first input operation, and
generates the first flower image according to the first parameter.

4. An information processing system comprising:
a user terminal according to claim 2; and
a server, wherein
the server comprises a server-side display control unit capable of communicating with the terminal-side display control unit, and
at least one of the terminal-side display control unit and the server-side display control unit holds at least one of first data corresponding to the basic shape and a first parameter corresponding to the shape state.

5. An information processing system comprising:
a user terminal according to claim 3; and
a server, wherein
the server comprises a server-side display control unit capable of communicating with the terminal-side display control unit, and
at least one of the terminal-side display control unit and the server-side display control unit holds at least one of first data corresponding to the basic shape and a first parameter corresponding to the shape state.

6. An information processing system comprising:
a user terminal comprising:
a terminal-side display control unit that generates an image;
a display unit that displays the image; and
an input unit that receives an input operation by a first user; and
a server comprising a server-side display control unit capable of communicating with the terminal-side display control unit, wherein
the server-side display control unit holds second data corresponding to a basic shape of a second flower corresponding to a second user and a second parameter corresponding to a shape state of the second flower, and
the terminal-side display control unit generates an image of the second flower according to the second data and the second parameter.

7. The information processing system according to claim 6, wherein
the input unit receives a second input operation by a first user,
the terminal-side display control unit performs a predetermined visual expression on the second flower image according to the second input operation.

8. The information processing system according to claim 7, further comprising a second user terminal comprising:
a second terminal-side display control unit;
a second display unit that displays the image; and
a second input unit that receives an input operation by a second user, wherein
the server-side display control unit notifies the second terminal-side display control unit of an occurrence of the second input operation, and
upon receiving the notification, the second terminal-side display control unit makes the second display unit display information that the second input operation has occurred.

9. An information processing method comprising:
a generation step of generating a first flower image corresponding to a first user;
an input step of receiving a first input operation by the first user; and
a change step of changing the first flower image according to the first input operation.

10. An information processing method comprising:
a step of holding, by a server-side display control unit, second data corresponding to a basic shape of a second flower corresponding to a second user and a second parameter corresponding to a shape state of the second flower, and
a step of generating, by a terminal-side display control unit, an image of the second flower according to the second data and the second parameter.

11. A program for causing a computer to execute a method according to claim 9.

12. A program for causing a computer to execute a method according to claim 10.
